(19) United States
(12) Patent Application Publication
(10) Pub. No.: US 2020/0307015 A1
(43) Pub. Date: Oct. 1, 2020

(54) CHAIN SAW GUIDE BAR

(71) Applicant: HUSQVARNA AB, Huskvarna (SE)

(72) Inventor: Christian Liliegård, Jönköping (SE)

(21) Appl. No.: 16/311,018

(22) PCT Filed: Jun. 19, 2017
(86) PCT No.: PCT/SE2017/050654

§ 371 Date: Dec. 18, 2018

(30) Foreign Application Priority Data
Jun. 21, 2016 (SE) 1650870-7

(51) Int. Cl. B27B 17/02

(52) U.S. Cl. CPC B27B 17/025

(57) ABSTRACT

The present disclosure relates to a guide bar (1) for a chain saw (3) with a proximal section (7), a distal section (13), and an intermediate section (15) between the proxymal and distal sections. The periphery of the guide bar defines a saw chain guide for guiding saw chain links along a path (31) from an engagement location (27) one edge of the bar to a disengagement location on the other. The periphery of the guide bar, where the saw chain links are supported only by the guide bar periphery has a curvature which is free from abrupt changes or step-wise changes. This provides a guide bar (1) less subject to wear during use.

### TECHNICAL FIELD

The present disclosure relates to a guide bar for a chain saw, having a proximal section configured to be connected to a drive unit of the chain saw, a distal section, and an intermediate section between the proximal and distal sections. A periphery of the guide bar defines a saw chain guide for guiding saw chain links along a path from an engagement location on one edge of the proximal section to a sprocket, if provided, and to a disengagement location on an opposite edge of the proximal section.

### BACKGROUND

Such a guide bar is disclosed for instance in U.S. Pat. No. 4,408,393-A, where convex side edges are provided, and a sprocket is used at the distal end of the guide bar. One general problem associated with guide bars in professional use is how to provide a guide bar that need be changed less frequently.

### SUMMARY

One object of the present disclosure is therefore how to provide a guide bar that is more economical to use. This object is achieved by means of a guide bar as defined in the independent claims. More specifically, a guide bar for a chain saw has a proximal section, configured to be connected to a drive unit of the chain saw, a distal section, and an intermediate section between the proximal and distal sections. A periphery of the guide bar defines a saw chain guide for guiding saw chain links along a chain path from an engagement location on one edge of the proximal section to a disengagement location on an opposite edge of the proximal section. The periphery of the guide bar has a curvature defined as the shortest distance x between a central reference point, pc, on the periphery, and a virtual straight line between first, pl₁, and second, pl₂, lateral reference points on the periphery, which are located at either side of the central reference point, pc, at a 1 mm distance the to the central reference point. The curvature x, at each position along said chain path where the saw chain links are supported only by the guide bar periphery, has a local rate of change Δx/ΔL being less than 0.01 mm for a ΔL=2 mm displacement.

Such a guide bar has experimentally been shown to be subject to less wear than a guide bar that has a step-wise change in curvature. This provides a guide bar that will last longer than a conventional guide bar and will need to be replaced less frequently.

Differently expressed, a guide bar for a chain saw comprises a proximal section configured to be connected to a drive unit of the chain saw, a distal section, and an intermediate section between the proximal and distal sections. A periphery of the guide bar defines a saw chain guide for guiding saw chain links along a chain path from an engagement location on one edge of the proximal section to a sprocket, if provided, in the distal section and to a disengagement location on an opposite edge of the proximal section. The periphery of the guide bar has a curvature which is free from abrupt changes at each position along said chain path where the saw chain links are supported only by the guide bar periphery.

The guide bar may comprise a sprocket guiding the saw chain in a part of the distal section, and the saw chain links may be supported by the sprocket in a 150° sector at the distal section, or more generally a sector in the range 105-180°. In this sector, a different curvature variation may be allowed. As the saw chain is radially supported by the sprocket this may not matter.

The guide bar may be formed by a plurality of layers, spot welded into a stack of layers, which form a groove along the guide bar periphery. The groove may have a uniform depth along said chain path in the intermediate and distal sections.

The periphery of the intermediate section may have a positive curvature x on both edges of the guide bar, i.e. the side edges are convex. In one example, the guide bar edge may be convex along the entire chain path from the point of engagement to the point of disengagement.

It is also considered a guide bar for a chain saw, as initially mentioned, where the proximal section has a peripheral shape with a curvature, in the direction the saw chain engages with the guide bar, which first increases and then decreases. More specifically, there is considered a guide bar for a chain saw, having a proximal section configured to be connected to a drive unit of the chain saw, a distal section, and an intermediate section between the proximal and distal sections. A periphery of the guide bar defines a saw chain guide for guiding saw chain links along a chain path from an engagement location on one edge of the proximal section to a sprocket, if provided, in the distal section and to a disengagement location on an opposite edge of the proximal section. The periphery of the guide bar has a curvature defined as the shortest distance x between a central reference point, pc, on the periphery, and a virtual straight line between first, pl₁, and second, pl₂, lateral reference points on the periphery, which are located at either side of the central reference point, pc, at a 1 mm distance the to the central reference point, wherein the curvature x has a positive rate of change in a first portion of the proximal section and a negative rate of change in a second portion of the proximal section in the direction a saw chain is intended to move when engaging with the guide bar, i.e. towards the distal section. This has shown to reduce wear at the location where the saw chain engages with the guide bar. Additionally, it has been shown that the saw chain may run in a more stable manner with a guide bar shaped accordingly, which gives a more efficient operation.

This guide bar may be varied and altered in accordance with the first example of the present disclosure, mentioned above.

### BRIEF DESCRIPTION OF THE DRAWINGS

FIG. 1 shows a perspective view of an example of a chainsaw.

FIG. 2 shows a side view of a guide bar according to the present disclosure.

FIG. 3 shows a cross section A-A indicated in FIG. 2.

FIG. 4 shows the distal section of the guide bar of FIG. 2.

FIG. 5 shows the proximal section of the guide bar of FIG. 2.

FIG. 6 illustrates the definition of curvature used in the present disclosure.

FIG. 7 illustrates the conversion between the definition of curvature used in the present disclosure and radius.

FIG. 8 shows a plot of the curvature and the differential curvature along a relevant portion of the guide bar of FIG. 2.

FIG. 9 illustrates schematically a first example of a prior art guide bar.

FIG. 10 illustrates schematically a second example of a prior art guide bar.

### DETAILED DESCRIPTION

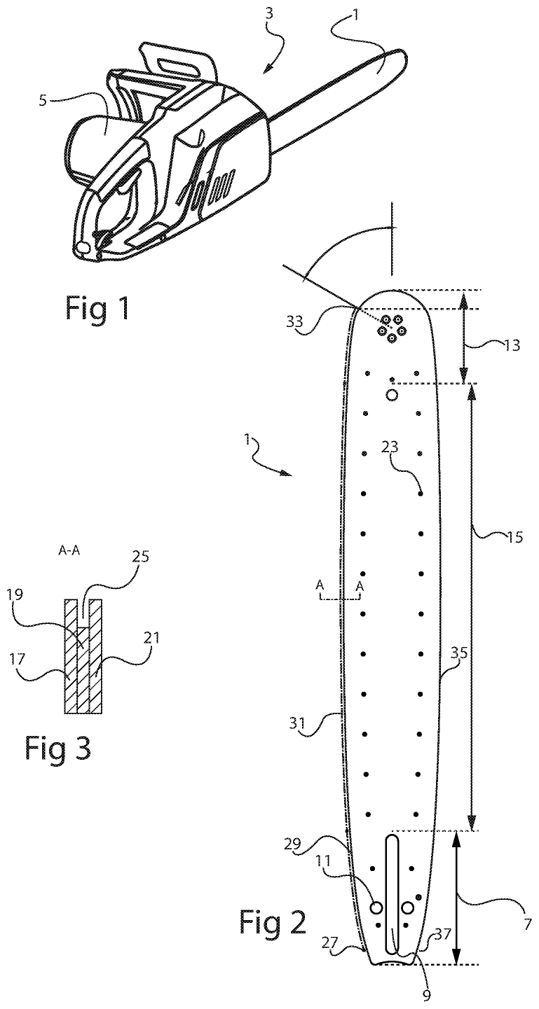

The present disclosure relates to an improved guide bar 1 for a chain saw 3, as illustrated in FIG. 1. The guide bar 1 is attached to the drive unit 5 of the chain saw 3 and guides the saw chain's movement around the periphery of the guide bar 1 to perform cutting. A guide bar 1 is subject to significant wear and will often need be replaced. Typically, a conventional guide bar 1 will last 3-4 saw chains.

FIG. 2 shows a side view of a guide bar 1 according to the present disclosure. The guide bar 1 has a proximal section 7, which is configured to be connected to the chain saw drive unit. For this purpose, the proximal section 7 is provided with a guide slot 9 and two mounting holes 11, as is well known per se. The arrangement used to attach the guide bar 1 to the drive unit may be devised differently.

The guide bar 1 further has a distal section 13, where the saw chain turns to return to the drive unit. Typically, the distal section is provided with a sprocket as will be discussed later. Examples without sprockets are conceivable, however.

In the present disclosure, the proximal section 7 is defined as the 100 mm of the guide bar 1 closest to the drive unit 5, while the distal section 13 is defined as the 75 mm of the guide bar 1 that are most distant from the drive unit.

In between the proximal 7 and distal 13 sections there is an intermediate section 15, which may be provided in different lengths. Typically, the total length of a guide bar is 13-18 inches (about 330-460 mm).

FIG. 3 illustrates schematically a cross section A-A through the periphery of the guide bar in the intermediate section 15. Typically, the guide bar is made up from three layers 17, 19, 21 of carbon steel sheet metal, which are welded together with spot welds 23 (cf. FIG. 2) to form a stack. The middle layer 19 has a smaller outer contour so as to provide a groove 25 along most of the periphery of the guide bar 1. The groove 25 is used to guide the links of the saw chain in a sliding motion as is well known per se. It should be noted that there exist other ways of providing a guide bar. For instance, the stack of layers can be glued, or a guide bar can be formed from a solid bar where a groove is machined in the periphery.

When the saw chain leaves the drive unit, it will engage with the guide bar 1 at an engagement location 27 on one edge 29 of the proximal section 7, and then follow a path 31 from the proximal section 7 via the intermediate section 15 to the distal section 13. If the distal section 13 is provided with a sprocket, as will be discussed, the sprocket will support the saw chain links at the portion where the links turn, and, if so, the path 31 where the guide bar groove 25 alone guides the links will end at a front end location 33. Once the saw chain links have turned, they may be guided by the opposite edge 35 of the guide bar 1 along a path more or less symmetrical with the first path 31, until the links leave the groove at a disengagement location 37. Even when guided by the sprocket, the saw chain may be laterally supported by the groove 25, while the sprocket supports the saw chain radially as defined by the axis of rotation of the sprocket.

FIGS. 9 and 10 illustrate, very schematically, examples of prior art guide bars. In FIG. 9, a very basic type of guide bar is shown where the edges of the intermediate sections are straight lines, and the straight edges are finished at the distal section with a half-circular shape, having the radius of a sprocket attached in the distal section, e.g. 30 mm. FIG. 10 illustrates schematically a second, evolved example, where the side edges of the intermediate section are somewhat curved, e.g. with a radius of about 2000 mm. The half circular shape of the distal end, still with a much smaller radius, is offset somewhat towards the proximal section, such that the softer curvature of the intermediate sections has the same inclination as has the distal end's sharper curvature at the location where they meet. The latter shape of FIG. 10 has the advantage that the groove will to some extent be kept clean by the saw chain links, and that the saw chain links will be kept tensioned due to the centrifugal force while being more effectively lubricated.

The present disclosure relies on the finding that not only the curvature, but also the rate at which the curvature changes along the periphery of the guide bar has a significant influence on the durability of the guide bar.

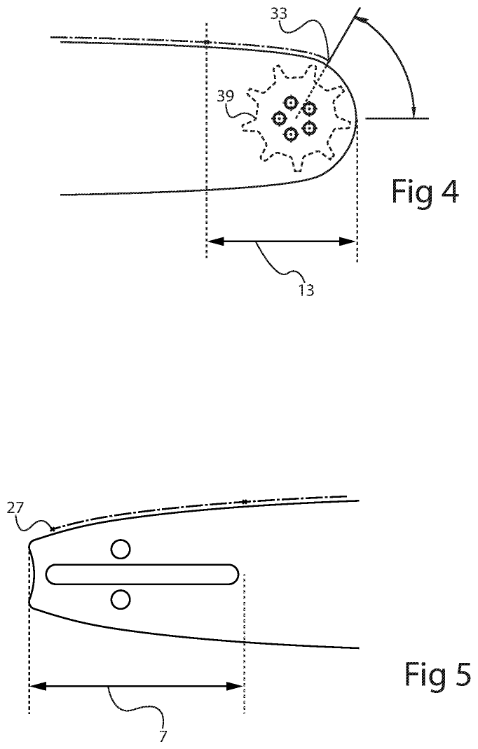

This influence is particularly significant in the previously mentioned distal 13 and proximal 7 sections of the guide bar. In the distal section 13 of FIG. 4, one point particularly subject to wear is the point 33 where the sprocket 39 engages with the saw chain. The sprocket 39 is arranged in the space between the outer sheet metal layers 17, 21 of the distal section.

In the proximal section of FIG. 5, the location 27 where the saw chain links land on the guide bar, is particularly subject to wear. For this reason, having particularly strict limits for curvature rate of change in these areas may be useful.

In the previously referenced document for instance, the curvature is defined with the local radius of the periphery, i.e. the radius of a circle that fits the curvature of a location. In the context of the present disclosure, however, that definition of a curvature is less useful. If any section of the periphery is a straight line, the radius at that location is infinite, as is of course any rate of change in the radius when moving to a location that is non-straight. Further, when analyzing the behavior of an individual saw chain link, it is clear that this link to a great extent is influenced by its location relative to neighboring chain links. Therefore, a definition of curvature based on the relative position of a given position on the periphery and first and second neighboring positions is considered more useful here. Needless to say, such a definition of curvature can be converted into a radius, as will be disclosed as well.

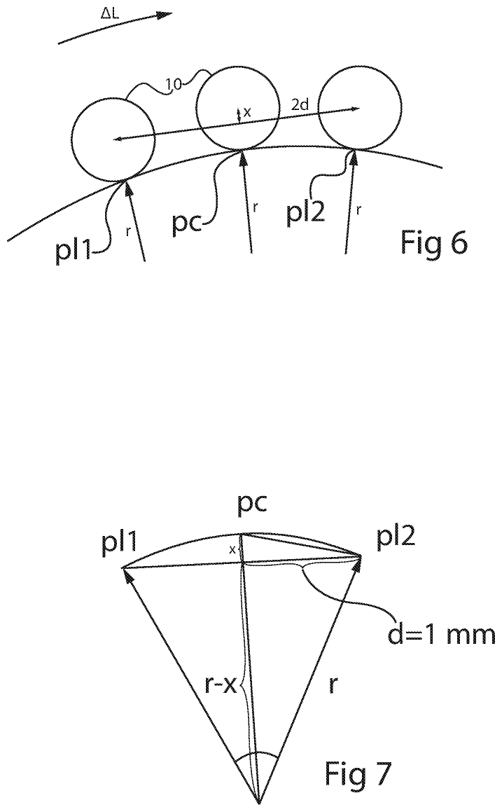

FIGS. 6 and 7 illustrate the definition of curvature used in the present disclosure. The curvature is defined for a central reference point, pc, on the periphery of the guide bar. There is defined a first, pl₁, and second, pl₂, lateral reference point, which are neighboring to the central reference point pc at each side thereof. According to this definition, the lateral reference points, pl₁, pl₂, are located on the periphery, mutually separated by 2 mm and located at equal distances to the central reference point pc, i.e. at each side of the central reference point at a distance of somewhat more than 1 mm.

A virtual straight line is drawn between the first, ph, and second, pl₂, lateral reference points, and the curvature is defined as the shortest distance x between this virtual line and the central reference point, pc, i.e. perpendicularly to the virtual line. As indicated in FIG. 6, a measurement tool comprising three small rollers 10, the middle one of which is movable along the radial direction r, can be used to measure the curvature; for the moderate curvatures generally used on a guide bar, a very close approximate value of x may thereby be obtained.

FIG. 7 illustrates the conversion between the definition of curvature used in the present disclosure and a corresponding radius. The Pythagorean theorem for d=1 mm defines that:

(r−x)²+1²=r²[mm]

Solving this gives the following conversion from r to x:

x=r±\sqrt{r²−1}[mm],

where the first solution (+) is ignored.

From x to r the conversion is given by:

$$r = \frac{{x}^{2} + 1}{2 x}$$

These equations can readily be changed to apply for other separations of the lateral reference points.

In the prior art examples given with reference to FIGS. 9 and 10, the curvature as defined above rises, at the transition between the sections of different radii, in a step from 0 mm to 0.017 mm in FIG. 9 (r=^{∞}to r=30 mm) in FIG. 9, and in FIG. 10 in a step from 0.00025 mm to 0.017 mm (r=2000 mm to r=30 mm).

The inventors of the present disclosure have found that step-wise curvature changes of this kind causes the guide bar to be excessively worn, and that step-wise changes may preferably be avoided, instead changing the curvature continuously.

In general, this can be stated as that in a new, unused guide bar as taken from the sales package, step-wise or abrupt changes in curvature are avoided. A more precise definition of the absence of abrupt curvature changes, using the above curvature expression x, can be defined as the curvature x having a local rate of change Δx/ΔL being 0.01 mm or less, even more preferred less than 0.006, for a ΔL=2 mm displacement at each position along the chain path where the saw chain links are radially supported only by the guide bar periphery. That is to say, where the saw chain is supported by a sprocket, the saw chain is only laterally supported by the peripheral groove. In this section, typically the front 150° at the distal section of the guide bar as illustrated in FIG. 2, the curvature may preferably be constant. However, e.g. a dent in the periphery would not affect the function in this sector, as long as the saw chain is laterally supported by the groove. In the proximal section, it may be preferred that the curvature x has an even lower local rate of change Δx/ΔL; preferably less than 0.003 mm, and even more preferred less than 0.001 mm, for a ΔL=2 mm displacement at each position along the chain path.

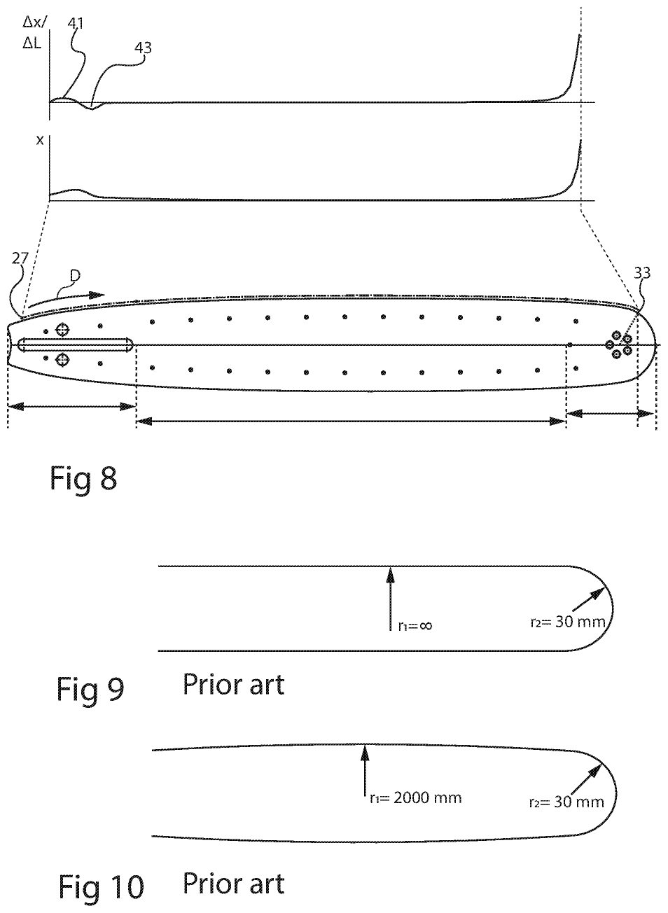

FIG. 8 shows a plot of the curvature x along a portion of the guide bar of FIG. 2, along the path from the engagement location 27 to the point 33 where the sprocket engages with the saw chain, i.e. along the saw chain path on the upper edge of the guide bar where the saw chain is supported by the guide bar periphery only. On top of this plot, another plot illustrating the differential Δx/ΔL of the curvature is shown, for ΔL=2 mm. As illustrated, the maximum curvature is reached at the point 33 where the sprocket becomes active. This curvature is x=0.017 mm with the present definition of curvature, which equals a 30 mm radius. At this point, the curvature remains constant until the saw chain link leaves the sprocket and again becomes supported by the guide bar periphery only on the lower edge of the guide bar. The curvature along the lower edge may be a mirror image of the curvature of the upper edge. As can be seen in the top plot, the curvature differential remains continuous along the entire path. There are no step-wise changes, and Δx/ΔL is less than 0.01 mm along the entire plot. A non-zero rate of change Δx/ΔL of the curvature along at least a portion of the distal section just prior to the point 33 allows the curvature x to gradually approach the curvature of the sprocket.

As illustrated in the top graph, the curvature increases in a first portion 41 of the proximal section and then decreases in a second portion 43 of the proximal section in the direction D a saw chain is intended to move when engaging with the guide bar. The curvature locally peaks at about x=0.003 mm according to the present definition, or at about 165 mm in radius. This locally higher curvature at the location where the saw chain lands on the guide bar helps reducing wear, and therefore gives a longer useful guide bar life. Further, the saw chain will have a more stable manner of landing on the guide bar.

The present disclosure is not limited to the examples given above, and may be varied and altered in different ways within the scope of the appended claims.

1. A guide bar for a chain saw, having a proximal section configured to be connected to a drive unit of the chain saw, a distal section, and an intermediate section between the proximal and distal sections, wherein a periphery of the guide bar defines a saw chain guide for guiding saw chain links along a chain path from an engagement location on one edge of the proximal section to a disengagement location on an opposite edge of the proximal section, wherein the periphery of the guide bar has a curvature defined as the shortest distance, x, between a central reference point on the periphery, and a virtual straight line between a first lateral reference point and a second lateral reference point on the periphery, wherein the first and second lateral reference points are located at either side of the central reference point at a 1 mm distance the to the central reference point, wherein the curvature x has a local rate of change Δx/ΔL being less than 0.01 mm for an ΔL=2 mm displacement at each position along said chain path where the saw chain links are supported only by the guide bar periphery.

2. The guide bar according to claim 1, wherein the guide bar comprises a sprocket guiding the saw chain in a part of the distal section.

3. The guide bar according to claim 2, wherein the saw chain links are supported by the sprocket in a sector ranging from 105-180° at the distal section.

4. The guide bar according to claim 1, wherein the guide bar is formed by a plurality of layers which form a groove along the guide bar periphery.

5. The guide bar according to claim 4, wherein the groove has a uniform depth along said chain path outside the proximal section.

6. The guide bar according to claim 1, wherein the periphery of the intermediate section has a positive curvature on both edges of the guide bar.

7. A guide bar for a chain saw, having a proximal section configured to be connected to a drive unit of the chain saw, a distal section, and an intermediate section between the proximal and distal sections, wherein a periphery of the guide bar defines a saw chain guide for guiding saw chain links along a chain path from an engagement location on one edge of the proximal section via the distal section, to a disengagement location on an opposite edge of the proximal section, wherein the periphery of the guide bar has a curvature defined as the shortest distance between a central reference point on the periphery, and a virtual straight line between a first lateral reference point and a second lateral reference point on the periphery, wherein the first and second lateral reference points are located at either side of the central reference point at a 1 mm distance the to the central reference point, wherein the curvature has a positive rate of change in a first portion of the proximal section and a negative rate of change in a second portion of the proximal section in a direction towards the distal section.
